(19) United States
(12) Patent Application Publication
(10) Pub. No.: US 2023/0406583 A1
(43) Pub. Date: Dec. 21, 2023

(54) METHOD FOR PRODUCING A SEALED VESSEL, VESSEL CLOSURE, AND VESSEL HAVING VESSEL CLOSURE

(71) Applicant: Silgan Holdings Inc., Hannover (DE)

(72) Inventors: Juergen KINTSCHER, Wedemark (DE); ANDREAS MANIERA, Neustadt (DE)

(21) Appl. No.: 18/036,819

(22) PCT Filed: Nov. 11, 2021
(86) PCT No.: PCT/IB2021/060460

§ 371 Date: May 12, 2023

(30) Foreign Application Priority Data
Nov. 13, 2020 (DE) 20207666.7

(51) Int. Cl. B65D 53/02; B65D 43/02; B65D 81/20

(52) U.S. Cl. CPC B65D 53/02; B65D 43/0231; B65D 81/2076; B65D 2543/00277; B65D 2543/00537; B65D 2543/00972

(57) ABSTRACT

The invention relates to a method for producing a sealed vessel, in which vessel it should be possible to store moisture-sensitive contents, and the vessel closure associated with which vessel should have improved recyclability. A vessel closure having a sealing element is provided. The sealing element comprises a polymer composition containing at least one polymer. The Shore A hardness of the polymer composition, determined in accordance with DIN ISO 7619 with a hold time of 15 s and a temperature of 23° C., is at most 80. A vessel having an opening is provided, the opening of the vessel being surrounding by a vessel mouth. The vessel closure is applied to the vessel mouth such that the opening of the vessel is sealed, the sealing element having a temperature of at most 80° C. during the application of the vessel closure to the vessel mouth, and/or an inert gas is introduced into a head space of the vessel and the vessel closure is applied to the vessel mouth such that the opening of the vessel is sealed by the vessel closure.

The invention relates to a method for producing a sealed vessel.

Furthermore, the invention relates to a vessel closure and to a vessel closed by the vessel closure.

Grainy or moisture-sensitive food (preparations), e.g. powdered milk, beverage preparations, or soluble coffee, are often stored in a vessel closed by a plastic material closure. To provide a moisture and flavor barrier during storage, an opening of the vessel is often additionally covered with a film, which is removed and disposed of by a user when the food (preparation) is first removed. A beverage or food product may be prepared by adding water or other liquid to the food (preparation). The food (preparation) can be removed from the vessel in portions, and the vessel can be resealed with the plastic closure after removal. The recycling process of the film and the plastic closure is costly. In addition, an aroma and moisture barrier after removal of the film and resealing by the plastic closure is not optimal.

An object of the invention is to provide a method by which a closed vessel can be produced, wherein a moisture-sensitive filling material can be stored in the vessel and the vessel and the associated vessel closure can be recycled in an improved manner. A further object of the invention is to provide a vessel closure which can close an opening of a vessel and which is suitable for a vessel for storing a moisture-sensitive filling material, wherein the vessel closure recycling is improved. A still further task is to provide a vessel with a vessel closure, wherein a moisture-sensitive filling material is storable in the vessel and vessel closure and vessel recycling are improved. A still further task is to provide a vessel closure for a vessel and a vessel closed with the vessel closure, wherein a filling material can be stored in the vessel and a user can reseal the vessel in an improved manner when the user removes filling material from the vessel in portions.

The object is achieved by a method according to claim 1, a vessel closure according to claim 12 or a vessel according to claim 13.

In a method for producing a sealed vessel or in a method for sealing a vessel, a vessel closure comprising a sealing element may be provided or may be already be provided. The sealing element may comprise a polymer composition. The polymer composition may include at least one polymer, such as a polyolefin. The Shore A hardness of the polymer composition may be at most 80. The Shore A hardness may be determined according to DIN ISO 7619 with a hold time of 15 s and a temperature of 23° C. A vessel with an opening can be provided. The opening of the vessel may be surrounded by a vessel mouth. The vessel closure may be applied to the vessel mouth such that the opening of the vessel is sealed. The sealing element may be at a temperature of at most 80° C. during application of the vessel closure to the vessel mouth.

In a method for producing a sealed vessel or in a method of sealing a vessel, a vessel closure comprising a sealing element may be provided or may be provided. The sealing element may comprise a polymer composition. The polymer composition may include at least one polymer, such as a polyolefin. The Shore A hardness of the polymer composition may be at most 80. The Shore A hardness may be determined according to DIN ISO 7619 with a hold time of 15 s and a temperature of 23° C. A vessel may be provided with an opening. The opening of the vessel may be surrounded by a vessel mouth. An inert gas may be introduced into a head space of the vessel. The vessel closure may be applied to the vessel mouth such that the opening of the vessel is sealed by the vessel closure.

The inert gas may be introduced primarily or exclusively into the head space of the vessel.

When the vessel closure is applied to the vessel mouth, a portion of the sealing element may contact a portion of the vessel mouth. In the sealed condition, the sealing element (a portion of the sealing element) may contact the vessel mouth (a portion of the vessel mouth).

The vessel closure can be applied to the vessel mouth at ambient temperature. The vessel closure can be applied to the vessel mouth without the use of steam, in particular water vapor. The vessel closure can be applied to the vessel mouth without a thermal treatment.

The sealing element may be annular or annularly disc-shaped or disc-shaped. The sealing element may be at least partially arranged in a (circumferential) recess in the vessel closure.

The polymer composition may be a thermoplastic elastomer. The polymer composition may be a thermoplastic elastomer composition.

The sealing element may comprise or consist of the polymer composition.

The vessel closure can be a screw closure. The vessel closure can be a lug cap closure. The vessel closure can be screwed onto the vessel mouth.

The vessel may be a glass vessel. The vessel may comprise glass or be made of glass. The vessel closure may be a metal closure. The vessel closure may comprise metal or be made of metal.

The outer diameter of the vessel closure can be at most 120 mm. Preferably, the outer diameter of the vessel closure is at most 100 mm or at most 90 mm. In particular, the outer diameter of the vessel closure is between 30 mm and 120 mm or between 40 mm and 100 mm.

A volume of maximum 5 L, preferably maximum 3 L, particularly preferably maximum 1 L, can be accommodated by the vessel.

A granular filling material can be introduced into the vessel, in particular a granular food or a granular food preparation. A powdered filling material can be introduced into the vessel, in particular a powdered food or a powdered food preparation. For example, powdered milk, a powdered beverage, a dried spice, a hygroscopic food, soluble coffee, dried vegetables, dried meat, dried fish or dried fruit may be introduced into the vessel.

A moisture-sensitive product (moisture-sensitive food or moisture-sensitive food preparation) can be introduced into the vessel. A moisture-sensitive product may spoil more quickly or lose its flavor or change its consistency if it comes into contact with moisture.

A filling material (food or food preparation) with a moisture content of less than 10% by weight, in particular less than 8% by weight, preferably less than 5% by weight, particularly preferably less than 3% by weight, can be introduced into the vessel.

The vessel, in particular the head space of the vessel, can be pressurized with an inert gas, in particular nitrogen. The pressure in the sealed vessel can be above ambient pressure (1 bar) at room temperature.

The vessel can be sealed with the vessel closure under an inert gas atmosphere, in particular a nitrogen atmosphere. The vessel can be filled with the product under an inert gas atmosphere, in particular a nitrogen atmosphere.

The vessel closure can be threaded onto the vessel mouth with a torque of at most 9.0 Nm {80 inch lbs.), preferably at most 7.9 Nm (70 inch lbs.), more preferably at most 6.8 Nm {60 inch lbs.), even more preferably at most 5.6 Nm (50 inch lbs.).

The vessel closure can be screwed onto the vessel mouth such that a torque of at most 3.4 Nm {30 inch lbs.), preferably at most 2.8 Nm (25 inch lbs.), more preferably at most 2.3 Nm (20 inch lbs.), even more preferably between 0.3 Nm (3 inch lbs.) and 2.8 Nm (25 inch lbs.), is required to remove the vessel closure from the vessel mouth. Thus, a user must apply at most this amount of torque to remove (screw on or unscrew) the vessel closure from the vessel.

The vessel closure can be applied to the vessel mouth in such a way that an interior space of the vessel is vented starting from an overpressure of at least 0.3 bar, preferably at least 0.5 bar, more preferably at least 0.7 bar, even more preferably at least 1.0 bar (valve function).

The vessel closure can be designed in such a way that an interior space of the vessel is vented (valve function) from an overpressure of at least 0.3 bar, preferably at least 0.5 bar, more preferably at least 0.7 bar, even more preferably at least 1.0 bar.

The sealing element of the vessel closure can be designed in such a way that an interior space of the vessel is vented (valve function) starting from an overpressure of at least 0.3 bar, preferably at least 0.5 bar, more preferably at least 0.7 bar, even more preferably at least 1.0 bar.

The sealing element may be at a temperature of at most 75° C., preferably at most 60° C., more preferably at most 55° C., more preferably at most 50° C., more preferably at most 45° C., more preferably at most 40° C., more preferably at most 35° C., more preferably at most 30° C., more preferably at most 25° C., during application of the vessel closure to the vessel mouth.

The sealing element may be at a temperature between 0° C. and 80° C., preferably between 5° C. and 70° C., more preferably between 10° C. and 60° C., more preferably between 10° C. and 50° C., more preferably between 10° C. and 35° C., during application of the vessel closure to the vessel mouth.

The Shore A hardness, determined according to DIN ISO 7619 with a hold time of 15 s and a temperature of 23° C., of the polymer composition can be at most 78, preferably at most 76, preferably at most 74, preferably at most 72, preferably at most 70, preferably at most 68, preferably at most 66, preferably at most 64, preferably at most 62, preferably at most 60, preferably at most 58, preferably at most 56, preferably at most 54, preferably at most 52, preferably at most 50.

The Shore A hardness of the polymer composition can be between 20 and 80, preferably between 25 and 75, more preferably between 30 and 70, more preferably between 30 and 65, more preferably between 30 and 60, most preferably between 35 and 60.

The compression set of the polymer composition, determined according to ASTM D 395, 70° C., 22 h, may be at least 50%, preferably at least 55%, more preferably at least 60%, more preferably at least 70%, more preferably at least 75%, more preferably at least 80%, more preferably at least 85%, more preferably at least 90%, more preferably at least 95%.

The compression set of the polymer composition can be between 50% and 120%, preferably the compression set is between 55% and 110%, more preferably between 55% and 100%, more preferably between 60 and 100%, more preferably between 70 and 100%, more preferably between 80 and 100%.

Any of the polymer compositions disclosed herein may comprise less than 90% by weight polyvinyl chloride (PVC), preferably less than 80% by weight PVC, more preferably less than 70% by weight PVC, more preferably less than 60% by weight PVC, more preferably less than 50% by weight PVC, more preferably less than 40% by weight PVC, more preferably less than 30% by weight PVC, more preferably less than 20% by weight PVC, more preferably less than 10% by weight PVC, more preferably less than 5% by weight PVC, more preferably less than 2% by weight PVC, particularly preferably no PVC. More particularly, the polymer composition is free of PVC.

The polymer composition may contain at least 30% by weight, preferably at least 40% by weight, more preferably at least 50% by weight, more preferably at least 60% by weight, more preferably at least 70% by weight, even more preferably at least 80% by weight, most preferably at least 90% by weight, of a 1-butene copolymer.

The comonomer content of 1-butene in the 1-butene copolymer may be at least 50%, preferably at least 60%, more preferably at least 70%, even more preferably at least 80%.

Ethene may be a comonomer of the 1-butene copolymer. The comonomer content of ethene in the copolymer may be less than 50% in the 1-butene copolymer, in particular less than 40%, preferably less than 30%, more preferably less than 20%.

The comonomer content of 1-butene in the 1-butene copolymer may be less than 50%, preferably less than 40%, more preferably less than 30%, even more preferably less than 20%.

Ethene may be a comonomer of the 1-butene copolymer. The comonomer content of ethene in the copolymer may be at least 50% in the 1-butene copolymer, in particular at least 60%, preferably at least 70%, more preferably at least 80%.

The polymer composition may contain (at least) two different types of polymers, preferably (at least) three different types of polymers.

The polymer composition may contain a polymer with a Shore D hardness, determined according to DIN ISO 7619-1 at 23° C., of at least 8, preferably of at least 20, more preferably of at least 40, in particular at most 70, preferably between 40 and 70. Alternatively or additionally, the polymer composition may contain a polymer with a Shore A hardness, determined according to DIN ISO 7619-1 at 23° C., of at least 40, preferably of at least 60, more preferably of at least 80, more preferably of at least 90.

The polymer may be present in the polymer composition in a proportion of at least 5% by weight, preferably at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, more preferably at least 90% by weight. Alternatively or additionally, the polymer may be present in the polymer composition in a proportion of at most 90% by weight, preferably at most 80% by weight, more preferably at most 70% by weight, more preferably at most 60% by weight, more preferably at most 50% by weight, more preferably at most 40% by weight, more preferably at most 30% by weight, more preferably at most 20% by weight, more preferably at most 10% by weight, more preferably at most 5% by weight.

The polymer composition may comprise a heterophasic copolymer, preferably the heterophasic copolymer is a heterophasic propene-ethene copolymer, in particular a heterophasic propene-ethene bipolymer.

A heterophasic copolymer comprises (at least) two phases, wherein one of the phases is a continuous phase and a second phase is dispersed therein. Preferably, the heterophasic copolymer is prepared by a multi-step reaction process wherein the first phase is prepared in one or more reactors and the second phase is prepared in one or more other reactors.

The proportion of dispersed phase in the heterophasic copolymer can be up to 30% by weight, in particular between 3% by weight and 27% by weight, even more particularly between 5% by weight and 20% by weight.

The proportion of the continuous phase in the heterophasic copolymer is preferably at least 70% by weight, more preferably between 73% and 97% by weight, even more preferably between 80% and 95% by weight.

the heterophasic copolymer is present in the polymer composition between 0.1% and 40% by weight, preferably between 5% and 35% by weight, more preferably between 7% and 30% by weight, even more preferably between 7% and 25% by weight, most preferably between 10% and 15% by weight.

The heterophasic copolymer may be present in the polymer composition between 0.1% and 40% by weight, preferably between 5% and 35% by weight, more preferably between 7% and 30% by weight, even more preferably between 7% and 25% by weight, most preferably between 10% and 15% by weight.

The polymer composition may contain a propene copolymer, preferably the propene copolymer is a propene-ethylene copolymer, in particular a propene-ethylene bipolymer.

The propene copolymer may be present in the polymer composition between 0.1% and 40% by weight, preferably between 5% and 35% by weight, more preferably between 7% and 30% by weight, even more preferably between 7% and 25% by weight, most preferably between 10% and 15% by weight.

The propene copolymer may be a random copolymer. The propene copolymer can be a bipolymer.

The polymer composition may include a propene homopolymer, preferably the propene homopolymer is a syndiotactic propene homopolymer.

The propene homopolymer may be present in the polymer composition in a proportion between 0.1% and 40% by weight, preferably between 5% and 35% by weight, more preferably between 7% and 30% by weight, even more preferably between 7% and 25% by weight, most preferably between 10% and 15% by weight.

The polymer composition may contain a 1-butene homopolymer.

The butene homopolymer may be present in the polymer composition in a proportion between 0.1% and 40% by weight, preferably between 5% and 35% by weight, more preferably between 7% and 30% by weight, even more preferably between 7% and 25% by weight, most preferably between 10% and 15% by weight.

The polymer composition may contain an ethene polymer, preferably the density of the ethene polymer is between 0.87 g cm⁻³ and 0.94 g cm⁻³, in particular the ethene polymer is an ethene homopolymer, especially LDPE. The ethene homopolymer can also be an HDPE.

The ethene polymer may be present in the polymer composition in a proportion between 0.1% and 30% by weight, preferably between 0.1% and 25% by weight, more preferably between 2% and 20% by weight, even more preferably between 2% and 15% by weight, most preferably between 3% and 10% by weight.

The polymer composition may include a block copolymer. Preferably, ethene is a comonomer of the block copolymer. The block copolymer may be an olefinic block copolymer. Ethene and a C3 to C10 alpha-olefin may be comonomers of the block copolymer. Preferably, ethene and 1-octene are comonomers of the block copolymer (as a bipolymer).

The polymer composition may contain a random copolymer. Preferably, ethene is a comonomer of the random copolymer. The random copolymer may be an olefinic random copolymer. Ethene and a C3 to C10 alpha-olefin may be comonomers of the random copolymer. Preferably, ethene and 1-octene are comonomers of the random copolymer (as a bipolymer). Similarly, ethene and 1-butene can be comonomers of the random copolymer (as a bipolymer).

The polymer composition may contain at least 30% by weight, preferably at least 40% by weight, more preferably at least 50% by weight, more preferably at least 60% by weight, more preferably at least 70% by weight, even more preferably at least 80% by weight, most preferably at least 90% by weight, of the block copolymer or the random copolymer.

The polymer composition may contain at least 30% by weight, preferably at least 40% by weight, more preferably at least 50% by weight, more preferably at least 60% by weight, more preferably at least 70% by weight, still more preferably at least 80% by weight, most preferably at least 90% by weight, of a polymer having a Shore A hardness, determined according to DIN ISO 7619-1 at 23° C., of at most 80.

The polymer composition may contain a polyolefin, preferably two different types of polyolefins, more preferably three different types of polyolefins.

The polymer composition may include a polyalphaolefin having a kinematic viscosity, determined according to ASTM D445/ISO 3104, of at least 4 cSt, at a temperature of 100° C.

The polymer composition may contain a polyalphaolefin with a dropping point, determined according to ASTM 5950, of at most −10° C.

The polyalphaolefin may have a kinematic viscosity at a temperature of 100° C., determined according to ASTM D445/ISO 3104, between 4 cSt and 1500 cSt, preferably between 50 cSt and 1000 cSt, more preferably between 120 cSt and 1000 cSt, even more preferably between 250 cSt and 1000 cSt.

The polyalphaolefin may have a dropping point, determined according to ASTM 5950, of at most −20° C., preferably of at most −30° C.

The polyalphaolefin may have a density, determined according to ASTM D4052, of up to 0.860 g cm⁻³, in particular between 0.825 g cm⁻³ and 0.855 g cm⁻³.

The polyalphaolefin may have an average molecular weight Mw, determined according to DIN 55672-1, of at least 440 Da, preferably between 440 Da and 12000 Da, particularly preferably between 1000 Da and 10000 Da, even more preferably between 3000 Da and 10000 Da.

The polyalphaolefin may be a metallocene polyalphaolefin, in particular wherein the polyalphaolefin was prepared using a metallocene catalyst.

The polyalphaolefin may be a homopolymer or a copolymer, and in particular the polyalphaolefin may comprise a C3 to C22 alpha-olefin as a (co)monomer.

The polyalphaolefin may comprise a C6 to C14 alpha-olefin, preferably a C8 to C10 alpha-olefin, as a (co)monomer. More particularly, the polyalphaolefin is a 1-decene homopolymer.

The polyalphaolefin may be present in the polymer composition between 0.10% and 50% by weight, preferably between 0.1% and 40% by weight, more preferably between 2% and 30% by weight, even more preferably between 2% and 25% by weight, most preferably between 3% and 15% by weight.

The polymer composition may comprise up to 15% by weight, preferably up to 8% by weight, more preferably up to 6% by weight, most preferably up to 5% by weight, of additives.

The additives may be selected from the group consisting of pigments, nucleating agents, brighteners, stabilizers, surfactants, lubricants, antioxidants and combinations thereof.

The polymer composition can have an oxygen transmission rate, determined according to DIN 53380, of less than 5000 cm³ m⁻² d⁻¹ bar⁻¹, more preferably of less than 4000 cm³ m⁻² d⁻¹ bar⁻¹, more preferably of less than 3000 cm³ m⁻² d⁻¹ bar⁻¹, more preferably less than 2500 cm³ m⁻² d⁻¹ bar⁻¹, more preferably less than 2000 cm³ m⁻² d¹ bar⁻¹, more preferably less than 1300 cm³ m⁻² d¹ bar⁻¹, more preferably less than 900 cm³ m⁻² d⁻¹ bar⁻¹, more preferably less than 750 cm³ m⁻² d⁻¹ bar⁻¹.

The polymer composition may have a total migration, determined in accordance with DIN-EN 1186-14, of at most 5.5 mg cm⁻², preferably at most 3.5 mg cm⁻², more preferably at most 2.5 mg cm⁻², most preferably at most 1.5 mg cm⁻².

Preferably, the polymer composition contains less than 10% by weight of (chemically) crosslinked polymers, more preferably less than 5% by weight, and particularly preferably the polymer composition contains no (chemically) crosslinked polymers.

Preferably, the polymer composition contains less than 10% by weight of styrene-containing polymers, more preferably less than 5% by weight, and particularly preferably the polymer composition contains no styrene-containing polymers.

Preferably, the polymer composition does not contain oxygen scavengers.

The polymer composition may comprise at most one polymeric component, e.g. a polyolefin. The polymer composition may comprise at most one polymeric component, e.g. a polyolefin, and (non-polymeric) additives.

The polymer composition may comprise at most one polymeric component, wherein the polymeric component is a random ethene copolymer or a block ethene copolymer. The polymeric component may have a Shore A hardness (23° C.) between 45 and 75. The polymeric component may have a compression set (70° C., 22 h) of at least 50%, particularly at least 60% or 65%.

The polymer composition may include a first polymer having a Shore A hardness (23° C.) between 40 and 80, preferably between 50 and 70, and a second polymer having a Shore D hardness (23° C.) between 30 and 80, preferably between 40 and 70, more preferably between 45 and 65.

The first polymer may have a compression set (70° C., 22 h) of at least 50%, preferably at least 55%, more preferably at least 60%, more preferably at least 65%, as an alternative to the Shore A hardness or in addition to the Shore A hardness.

The first polymer may be present in the polymer composition in a proportion of between 30% by weight and 75% by weight, preferably between 35% by weight and 70% by weight, more preferably between 40% by weight and 65% by weight.

The second polymer may be present in the polymer composition in a proportion of between 2% by weight and 30% by weight, preferably between 5% by weight and 25% by weight, more preferably between 8% by weight and 18% by weight.

The first polymer may be a random ethene copolymer or a block ethene copolymer. The second polymer may be a random ethene copolymer (different from the first polymer) or a block ethene copolymer (different from the first polymer).

A C3 to C16(alpha-)olefin may be a comonomer of the first polymer. The first polymer may comprise ethene and a C3 to C16(alpha-)olefin as comonomers.

A C3 to C8(alpha-)olefin may be a comonomer of the first polymer. The first polymer may comprise ethene and a C3 to C8(alpha-)olefin as comonomers.

The first polymer may be a 1-butene copolymer (e.g., a 1-butene copolymer disclosed herein) or a block copolymer (e.g., a block copolymer disclosed herein). The second polymer may be a propene copolymer (e.g., a propene copolymer disclosed herein), preferably a random propene copolymer or a heterophasic propene copolymer. The second polymer may be a (syndiotactic) propene homopolymer, a 1-butene homopolymer, or an ethene homopolymer.

The polymer composition may comprise up to 40% by weight of a component liquid at 23° C. and 1 bar, e.g. a polyalphaolefin disclosed herein. The polymer composition may comprise up to 35% by weight, preferably up to 30% by weight, more preferably up to 25% by weight, more preferably up to 15% by weight, of a component liquid at 23° C. and 1 bar.

Preferably, the polymer composition has no melting temperature Tₘ. The melting temperature Tₘ can be determined by the second heating curve at a heating rate of 10° C./min during a DSC measurement.

The polymer composition can be (completely) amorphous.

The vessel closure or vessel may include a tamper evidence feature. A tamper evidence feature allows a consumer to detect that the vessel closure has not yet been opened or that the vessel closure has already been opened.

The tamper evidence feature may be formed and disposed on the vessel closure or the vessel such that the vessel closure cannot be removed from the vessel without at least partially destroying the tamper evidence feature.

The tamper evidence feature may be formed and disposed on the vessel closure or the vessel such that the tamper evidence feature is at least partially destroyed when the vessel closure is removed from the vessel.

A sealing element is disclosed, which has a polymer composition disclosed herein.

A sealing element disclosed herein may comprise or consist of a polymer composition disclosed herein.

A vessel closure for closing an opening of a vessel may comprise a sealing element. The sealing element may comprise a polymer composition. The polymer composition may comprise a polymer, preferably a polyolefin. The polymer composition may have a Shore A hardness, determined according to DIN ISO 7619 with a hold time of 15 s and a temperature of 23° C., of at most 80. The polymer composition may have a compression set, determined according to ASTM D 395, 70° C., 22 h, of at least 50%.

The vessel closure can be a screw closure, in particular a lug cap closure. The vessel closure can be screwed onto the vessel mouth.

The vessel closure can be a metal closure.

The polymer composition of the vessel closure may have any property disclosed herein. The polymer composition of the vessel closure may have any composition disclosed herein.

Generally, the sealing element may have a weight of at most 25 g, preferably at most 20 g, more preferably at most 15 g, more preferably at most 10 g, more preferably at most 5 g, more preferably at most 3 g, more preferably at most 2 g.

If the vessel closure ha a diameter, in particular an outer diameter, between 48 mm and 58 mm, in particular about 53 mm, a weight of the sealing element in the vessel closure may be at most 10 g, preferably at most 2 g.

If the vessel closure has a diameter, in particular an outer diameter, between 77 mm and 87 mm, in particular about 82 mm, a weight of the sealing element in the vessel closure may be at most 18 g, preferably at most 3 g.

A vessel may have an opening closed by a vessel closure. The opening of the vessel may be surrounded by a vessel mouth. The vessel closure may be a vessel closure disclosed herein.

The vessel may be a vessel disclosed herein.

A filling material may be stored in the vessel. Any filling material disclosed herein may be stored in the vessel.

The vessel, in particular the head space of the vessel, may be pressurized with nitrogen. In general, the vessel, in particular the head space of the vessel, may be pressurized with an inert gas.

A vessel or a head space of the vessel may comprise a gas. The gas may have an inert gas content, in particular a nitrogen content, of at least 78.5% by volume, preferably at least 80% by volume, more preferably at least 81% by volume, more preferably at least 82% by volume, more preferably at least 83% by volume, more preferably at least 85% by volume, more preferably at least 90% by volume, most preferably at least 95% by volume or 98% by volume.

The filling material can be granular or porous. The filling material can be introduced into the vessel under ambient atmosphere (ambient air). The head space of the vessel filled with the filling material can be pressurized or purged with an inert gas.

Since the filling material is granular or porous, the gas in the vessel may contain a proportion of oxygen from the ambient atmosphere. This is also the case when the head space is pressurized or purged with the inert gas. The proportion of oxygen may be less than the proportion of oxygen in the ambient atmosphere.

The proportion of oxygen in the vessel, in particular in the filled and sealed vessel, may be at most 20.8% by volume, preferably at most 20.5% by volume, more preferably at most 20% by volume, more preferably at most 19% by volume, more preferably at most 18% by volume, more preferably at most 17% by volume, more preferably at most 15% by volume, more preferably at most 10% by volume, more preferably at most 5% by volume.

The absolute pressure in the vessel at 23° C. can be more than 1 bar, preferably more than 1.1 bar, more preferably more than 1.2 bar, more preferably more than 1.3 bar, more preferably more than 1.4 bar.

The vessel closure may be applied to the vessel mouth such that the vessel closure can be unscrewed from the vessel by a rotation relative to the vessel of at most 270°, preferably at most 180°, more preferably at most 120°.

An embodiment of a vessel closure and of a vessel is described below with reference to figures. In this regard, no limitations in the description or figures are to be transferred to the claims.

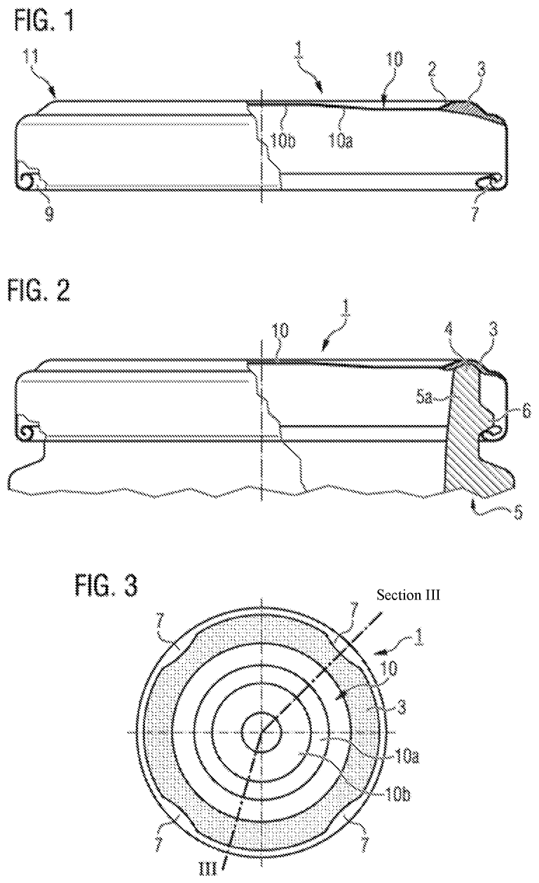

FIG. 1 shows a side view of a lug cap closure 1 with an annular sealing element 3, in a partial sectional view;

FIG. 2 shows a side view of the lug cap closure 1 with the sealing element 3 on a vessel 5, in a partial sectional view;

FIG. 3 shows the lug cap closure 1 with the sealing element 3 in a bottom view; and

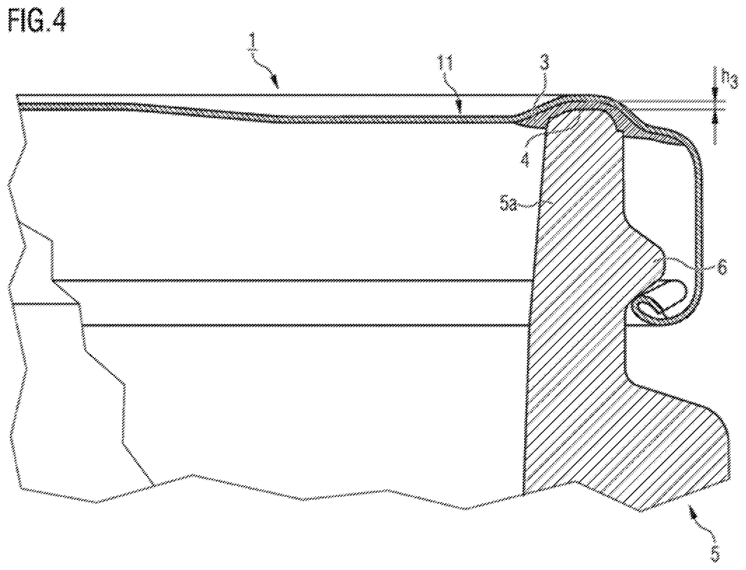

FIG. 4 shows an enlarged detail of the lug cap closure of FIG. 2.

FIGS. 1 and 3 show a vessel closure 1, in particular a lug cap closure. The lug cap closure 1 may comprise a metallic support 11 and may comprise a sealing element 3. In the embodiment of FIG. 2, the lug cap closure 1 is applied to a vessel 5. A curl 9 may be formed at the lower end of the lug cap closure 1. A plurality of lugs 7 may be formed circumferentially distributed from the curl 9. Lugs 7 may be formed by axially deforming the curl 9, and may extend radially further toward the center of the lug cap closure 1 than the curl 9. The lug cap closure 1 illustrated in FIGS. 1 to 3 may include four lugs 7, which may be formed circumferentially while being evenly distributed. The sections partially illustrated in FIGS. 1 and 2 correspond to section III-III in FIG. 3.

Generally, the vessel closure may have at least 3 lugs, preferably at least 4 lugs, preferably at least 6 lugs. The vessel closure may have from 3 to 6 lugs.

Near the radially outer end portion of the lug cap closure 1, a channel 2 may be formed in the upper portion 10 of the support 11. The sealing element 3 may be at least partially disposed in the channel 2. In this embodiment, the sealing element 3 may be annular in shape, while in other embodiments the sealing element 3 may be disc-shaped, in particular if the diameter of the lug cap closure is small (e.g. 30 mm at most).

For adhesion between the metallic support 11 and the sealing element 3, an adhesive lacquer may be applied to the side of the metallic support 11 that is in contact with the sealing element 3.

In FIG. 2, the lug cap closure 1 is applied onto a vessel 5. The vessel 5 may comprise a vessel mouth 5a as an upper portion of the vessel 5. The vessel mouth may comprise a thread 6 and may comprise an upper end 4 of the vessel mouth 5a. The thread 6 may be formed circumferentially in the region of the vessel mouth 5a, and may extend circumferentially upwardly or downwardly (depending on the angle of view).

To apply the lug cap closure 1 to a vessel 5, lugs 7 can be brought into contact with portions of the thread 6, and the lug cap closure 1 can be rotated clockwise relative to the vessel 5. Due to the configuration of the thread 6 and the interaction of the lugs 7 with the thread 6, the upper end 4 of the vessel mouth 5a can move towards the sealing element 3 during the rotational movement of the lug cap closure 1 relative to the vessel 5. Further rotational movement of the lug cap closure 1 may cause the upper end 4 of the vessel mouth 5a to press into the sealing element 3, and may deform the same such that a portion of the upper end 4 of the vessel mouth 5a may be covered by the sealing element 3, thereby sealing the vessel 5 tightly. A tight seal of the vessel 5 is particularly necessary in order to withstand an increased pressure in the head space, which may be caused for example by nitrogen or other inert gas pressurization. A pressure change, for example an increased or reduced pressure, may also be caused by a temperature and/or an ambient pressure change. The ambient pressure change may be caused by a change in the altitude of the vessel.

The lug cap closure 1, as shown in FIGS. 1 to 3, comprises a Safety Button 10b, which may be formed in the upper portion 10 of the support 11. Due to the slope 10a in the upper portion 10 of the support 11, the Safety Button 10b can flip towards the center of the vessel when there is a sufficiently large negative pressure in the vessel. The Safety Button 10b is optional and is used when it is advantageous for the particular application. If there is an overpressure in the vessel under (normal, e.g. ambient) storage conditions, a Safety Button is generally not required.

The distance h₃ of a sealing element 3 between an upper end 4 of a vessel mouth 5a of a vessel 5 and the lower side of a support 11 of the closure 1 is shown in FIG. 4, looking at a lug cap closure 1.

The sealing element 3 clamped between the vessel mouth 5 and the support 11 of the vessel closure 1 has a height h₃, which is present when a vessel 5 is closed with the closure 1. If the height h₃ is too small, there is a risk of the sealing element 3 being cut through, which may impair the tightness of the sealed vessel 5. If the height h₃ is too large, the tightness of the closed vessel is impaired because the contact area between the upper end 4 of the vessel mouth 5a and the sealing element 3 is not sufficiently large. A proper impression of the upper end 4 of the vessel mouth 5a into the sealing element is desirable.

### EXAMPLES

Examples of polymer compositions for sealing elements in a vessel closure are shown in Tables 1 to 3.

TABLE 1

| | Example 1 | Example 2 | Example 3 | Example 4 | Example 5 | Example 6 |
|---|---|---|---|---|---|---|
| Component | | | | | | |
| C4C2, % by weight | 95.9 | 85.9 | | | 57.5 | |
| PAO I, % by weight | | 10.0 | | | | |
| PAO II, % by weight | | | | | 20.0 | 20.0 |
| C2C8, % by weight | | | 95.9 | | | 57.5 |
| C2C4 I, % by weight | | | | 95.9 | | |
| C2C4 II, % by weight | | | | | | |
| C3C2 I, % by weight | | | | | 12.8 | 12.8 |
| C3C2 II, % by weight | | | | | | |
| C3, % by weight | | | | | | |
| C4, % by weight | | | | | | |
| C2, % by weight | | | | | 6.4 | 6.4 |
| Additives, % by weight | 4.1 | 4.1 | 4.1 | 4.1 | 3.3 | 3.3 |
| Features | | | | | | |
| Coefficient of friction, | 0.62 | 0.41 | | 0.87 | 0.39 | |
| dimensionless | | | | | | |
| Overall migration, | 1.1 | 1.6 | | 2.0 | 5.1 | |
| mg cm⁻² | | | | | | |
| OTR, | 671 | 633 | | 1399 | 1162 | |
| cm³ m⁻² d⁻¹ bar⁻¹ | | | | | | |
| DVR 70° C., % | 98 | 84 | 70 | 114 | 83 | 76 |
| Shore A 23° C., | 61 | 48 | 60 | 55 | 67 | 45 |
| dimensionless | | | | | | |
| DSC Tm max | no | no | | no | 156 | |

TABLE 2

| | Example 7 | Example 8 | Example 9 | Example 10 | Example 11 | Example 12 |
|---|---|---|---|---|---|---|
| Component | | | | | | |
| C4C2, % by weight | | 57.5 | | 57.5 | | 57.5 |
| PAO I, % by weight | | | | | | |
| PAO II, % by weight | 10.0 | 20.0 | 20.0 | 20.0 | 20.0 | 20.0 |
| C2C8, % by weight | | | 57.5 | | 57.5 | |
| C2C4 I, % by weight | | | | | | |
| C2C4 II, % by weight | 85.9 | | | | | |
| C3C2 I, % by weight | | | | | | |
| C3C2 II, % by weight | | 12.8 | 12.8 | | | |
| C3, % by weight | | | | 12.8 | 12.8 | |
| C4, % by weight | | | | | | 12.8 |
| C2, % by weight | | 6.4 | 6.4 | 6.4 | 6.4 | 6.4 |
| Additives, % by weight | 4.1 | 3.3 | 3.3 | 3.3 | 3.3 | 3.3 |
| Features | | | | | | |
| Coefficient of friction, | 0.74 | | | | | |
| dimensionless | | | | | | |
| Overall migration, | 2.3 | | | | | |
| mg cm⁻² | | | | | | |
| OTR, | 1447 | | | | | |
| cm³ m⁻² d⁻¹ bar⁻¹ | | | | | | |
| DVR 70° C., % | 91 | | | | | |
| Shore A 23° C., | 50 | | | | | |
| dimensionless | | | | | | |
| DSC Tm max | no | | | | | |

TABLE 3

| | Example 13 | Example 14 | Example 15 |
|---|---|---|---|
| Component | | | |
| C4C2, % by weight | | | 64.7 |
| PAO I, % by weight | | | |
| PAO II, % by weight | 20.0 | | 10.0 |
| C2C8, % by weight | 57.5 | | |
| C2C4 I, % by weight | | 95.9 | |
| C3C2 I, % by weight | | | 14.4 |
| C3C2 II, % by weight | | | |
| C3, % by weight | | | |
| C4, % by weight | 12.8 | | |
| C2, % by weight | 6.4 | | 7.2 |
| Additives, % by weight | 3.3 | 4.1 | 3.7 |
| Features | | | |
| Coefficient of friction, | | 0.87 | 0.31 |
| dimensionless | | | |
| Overall migration, | | 2.0 | 3.3 |
| mg cm⁻² | | | |
| OTR, | | 1399 | 808 |
| cm³ m⁻² d⁻¹ bar⁻¹ | | | |
| DVR 70° C., % | | 114 | 83 |
| Shore A 23° C., | | 55 | 61 |
| dimensionless | | | |
| DSC Tm max | | no | 158 |

C4C2 is a 1-butene-ethylene copolymer with a 1-butene content of more than 80%. The density is 0.870 g cm⁻³. The Shore A hardness is 60.
PAO I is a (metallocene) polyalphaolefin (alpha-decene homopolymer) with a kinematic viscosity at 100° C. of about 65 cSt.
PAO II is a polyalphaolefin (alpha-decene homopolymer) with a kinematic viscosity at 100° C. of about 150 cSt.
C2C8 is an ethene-1-octene block copolymer with a compression set at 70° C. of 70% and a Shore A hardness (23° C.) of 60. For example, Dow's Infuse ™ series of olefinic block copolymers can be used.
C2C4 I is a random ethene-butene copolymer, in particular a random ethene-1-butene copolymer with a Shore A hardness of 52. The C2C4 can have a density of 0.862 g cm⁻³
C2C4 II is a random ethene-butene copolymer, in particular a random ethene-1-butene copolymer with a Shore A hardness of 64. The C2C4 can have a density of 0.865 g cm⁻³.
C3C2 I is a propene-ethene copolymer, the continuous phase being formed by homo-polypropene and the phase dispersed therein being formed by a propene-ethene copolymer.
C3C2 II is a random propene-ethene copolymer. It has a Shore D hardness (23° C., 15 s) of 58, an MFI (230° C., 2.16 kg) of 7 g/10 min and a density of 0.900 g cm⁻³.
C3 is a polypropene homopolymer, e.g., a syndiotactic polypropene homopolymer.
C4 is a 1-butene homopolymer with a Shore D hardness of 54 or 58.
C2 is a polyethene homopolymer, e.g. a low density polyethylene.

The coefficient of friction shown in Table 1 is the static coefficient of friction determined according to DIN EN ISO 8295.

In general, the polymer composition can have a static coefficient of friction of at most 1.0, preferably at most 0.8, more preferably at most 0.7.

The total migration of Table 1 is determined according to DIN EN 1186-14.

The OTR (oxygen transmission rate) is determined according to DIN 53380.

The melting temperature Tₘ was determined by a second heating curve of a DSC measurement at a heating rate of 10° C. min⁻¹. A value of “no” means that no melting temperature could be determined, i.e. a melting temperature is not present in the composition.

In general, no specific component is necessarily present in the polymer composition. In particular, an increased occurrence of a component in the examples is not an indication that this component must necessarily be present in the polymer composition. Rather, components may be omitted from the compositions of the examples or replaced by other component(s). Likewise, components can also be added.

In particular, components C2C4 I and C2C4 II may be interchangeable in the compositions.

Generally, in the compositions, component C2C4 I or C2C4 II may be replaced by C4C2. The polymer compositions may contain a 1-butene-ethylene copolymer instead of C2C4 I or C2C4 II.

Exemplary embodiments of the disclosure are listed and numbered below.

1. A method for producing a sealed vessel, wherein
(a) a vessel closure with a sealing element is provided, wherein the sealing element comprises a polymer composition and the polymer composition contains at least one polymer, wherein the Shore A hardness of the polymer composition, determined according to DIN ISO 7619 with a hold time of 15 s and a temperature of 23° C., is at most 80;
(b) a vessel having an opening is provided, wherein the opening of the vessel is surrounded by a vessel mouth;
(c) the vessel closure is applied to the vessel mouth such that the opening of the vessel is closed, wherein the sealing element has a temperature of at most 80° C. during application of the vessel closure to the vessel mouth.

2. The method of example 1, wherein the vessel closure is a screw closure, in particular a lug cap closure, and the vessel closure is screwed onto the vessel mouth.

3. The method of example 1 or 2, wherein the vessel is a glass vessel and/or the vessel closure is a metal closure.

4. The method of any one of the preceding examples, wherein the outer diameter of the vessel closure is at most 120 mm, preferably at most 100 mm, more preferably at most 90 mm.

5. The method of any one of the preceding examples, wherein a volume of at most 5 L, preferably at most 3 L, particularly preferably at most 1 L, can be accommodated by the vessel.

6. The method of any one of the preceding examples, wherein a granular filling material, in particular a granular filling material with a water content of at most 10% by weigh, is introduced into the vessel.

7. The method of any one of the preceding examples, wherein the vessel, in particular a head space of the vessel, is pressurized with an inert gas, in particular nitrogen.

8. The method of any one of the preceding examples, wherein the vessel closure is applied to the vessel mouth with a torque of at most 9.0 Nm {80 inch lbs.), preferably at most 7.9 Nm (70 inch lbs.), more preferably at most 6.8 Nm {60 inch lbs.), even more preferably of at most 5.6 Nm (50 inch lbs.).

9. The method of any of the preceding examples, wherein the vessel closure is threaded onto the vessel mouth such that a torque of at most 3.4 Nm {30 inch lbs.), preferably at most 2.8 Nm (25 inch lbs.), more preferably at most 2.3 Nm (20 inch lbs.), even more preferably between 0.3 Nm (3 inch lbs.) and 2.8 Nm (25 inch lbs.), is required to remove the vessel closure from the vessel mouth.

10. The method of any one of the preceding examples, wherein the vessel closure is applied to the vessel mouth such that an interior space of the vessel is vented starting from an overpressure of at least 0.3 bar, preferably at least 0.5 bar, more preferably at least 0.7 bar, even more preferably at least 1.0 bar.

11. The method of any one of the preceding examples, wherein the sealing element has a temperature of at most 60° C., preferably at most 40° C., more preferably between 10° C. and 40° C., during application of the vessel closure to the vessel mouth.

12. The method of any one of the preceding examples, wherein the Shore A hardness, determined according to DIN ISO 7619 with a hold time of 15 s and a temperature of 23° C., of the polymer composition is at most 70, preferably at most 65, more preferably between 30 and 65.

13. The method of any one of the preceding examples, wherein the compression set of the polymer composition, determined according to ASTM D 395, 70° C., 22 h, is at least 50%, preferably at least 60%, more preferably at least 65%, more preferably at least 70%, more preferably at least 75%, more preferably at least 80%, even more preferably at least 85%.

14. The method of any one of the preceding examples, wherein the polymer composition contains less than 10% by weight polyvinyl chloride (PVC), preferably less than 5% by weight PVC, more preferably less than 2% by weight PVC, particularly preferably no PVC.

15. The method of any one of the preceding examples, wherein the polymer composition contains at least 30% by weight, preferably at least 40% by weight, more preferably at least 50% by weight, more preferably at least 60% by weight, more preferably at least 70% by weight, even more preferably at least 80% by weight, most preferably at least 90% by weight, of a 1-butene copolymer.

16. The method of example 15, wherein the comonomer content of 1-butene of the 1-butene copolymer is at least 50%, preferably at least 60%, more preferably at least 70%, even more preferably at least 80%.

17. The method of example 15 or 16, wherein ethene is a comonomer of the 1-butene copolymer, in particular ethene has a comonomer content of less than 50% in the 1-butene copolymer.

18. The method of any one of the preceding examples, wherein the polymer composition comprises at least two different types of polymers, preferably at least three different types of polymers.

19. The method of any one of the preceding examples, wherein the polymer composition comprises a polymer having a Shore D hardness, determined according to DIN ISO 7619-1 at 23° C., of at least 8, preferably of at least 20, more preferably of at least 40, in particular at most 70, preferably between 40 and 70; and/or
wherein the polymer composition contains a polymer having a Shore A hardness, determined according to DIN ISO 7619-1 at 23° C., of at least 40, preferably of at least 60, more preferably of at least 80, more preferably of at least 90.

20. The method of any one of the preceding examples, wherein the polymer composition comprises a heterophasic copolymer, preferably wherein the heterophasic copolymer is a heterophasic propene-ethylene copolymer, in particular a heterophasic propene-ethylene bipolymer.

21. The method of example 20, wherein the heterophasic copolymer contained in the polymer composition is between 0.1% by weight and 40% by weight, preferably between 5% by weight and 35% by weight, more preferably between 7% and 30% by weight, even more preferably between 7% and 25% by weight, most preferably between 10% and 15% by weight.

22. The method of any one of the preceding examples, wherein the polymer composition comprises a propene copolymer, preferably wherein the propene copolymer is a propene-ethylene copolymer, in particular a propene-ethylene bipolymer.

23. The method of example 22, wherein the propene copolymer contained in the polymer composition is between 0.1% and 40% by weight, preferably between 5% and 35% by weight, more preferably between 7% and 30% by weight, even more preferably between 7% and 25% by weight, most preferably between 10% and 15% by weight.

24. The method of any one of examples 22 or 23, wherein the propene copolymer is a random copolymer.

25. The method of any one of the preceding examples, wherein the polymer composition comprises a propene homopolymer, preferably wherein the propene homopolymer is a syndiotactic homopolymer.

26. The method of example 25, wherein the propene homopolymer contained in the polymer composition is between 0.1% and 40% by weight, preferably between 5% and 35% by weight, more preferably between 7% and 30% by weight, even more preferably between 7% and 25% by weight, most preferably between 10% and 15% by weight.

27. The method of any one of the preceding examples, wherein the polymer composition comprises a 1-butene homopolymer.

28. The method of example 27, wherein the butene homopolymer contained in the polymer composition is between 0.1% and 40% by weight, preferably between 5% and 35% by weight, more preferably between 7% and 30% by weight, even more preferably between 7% and 25% by weight, most preferably between 10% and 15% by weight.

29. The method of any one of the preceding examples, wherein the polymer composition comprises an ethene polymer, preferably wherein the density of the ethene polymer is between 0.87 g cm⁻³ and 0.94 g cm⁻³, in particular the ethene polymer is an ethene homopolymer, especially LDPE.

30. The method of example 29, wherein the ethene polymer contained in the polymer composition is between 0.1% and 30% by weight, preferably between 0.1% and 25% by weight, more preferably between 2% and 20% by weight, even more preferably between 2% and 15% by weight, most preferably between 3% and 10% by weight.

31. The method of any one of the preceding examples, wherein the polymer composition comprises a random copolymer, preferably wherein ethene is a comonomer of the random copolymer, more preferably wherein ethene and a C3 to C10 alpha-olefin are comonomers of the random copolymer; and/or wherein the polymer composition comprises a block copolymer, preferably wherein ethene is a comonomer of the block copolymer, more preferably wherein ethene and a C3 to C10 alpha-olefin are comonomers of the block copolymer.

32. The method of any one of the preceding examples, wherein the polymer composition comprises at least 30% by weight, preferably at least 40% by weight, more preferably at least 50% by weight, more preferably at least 60% by weight, more preferably at least 70% by weight, even more preferably at least 80% by weight, most preferably at least 90% by weight, of the random copolymer or the block copolymer.

33. The method of any one of the preceding examples, wherein the polymer composition contains at least 30% by weight, preferably at least 40% by weight, more preferably at least 50% by weight, more preferably at least 60% by weight, more preferably at least 70% by weight, still more preferably at least 80% by weight, most preferably at least 90% by weight, of a polymer having a Shore A hardness, determined according to DIN ISO 7619-1 at 23° C., of at most 80.

34. The method of any one of the preceding examples, wherein the polymer composition comprises one polyolefin, preferably two different types of polyolefins, more preferably three different types of polyolefins.

35. The method of any one of the preceding examples, wherein the polymer composition contains a polyalphaolefin having a kinematic viscosity, determined according to ASTM D445/ISO 3104, of at least 4 cSt, at a temperature of 100° C., and/or having a dropping point, determined according to ASTM 5950, of at most −10° C.

36. The method of example 35, wherein the polyalphaolefin has a kinematic viscosity at a temperature of 100° C., determined according to ASTM D445/ISO 3104, between 4 cSt and 1500 cSt, preferably between 50 cSt and 1000 cSt, more preferably between 120 cSt and 1000 cSt, even more preferably between 250 cSt and 1000 cSt.

37. The method of example 35 or 36, wherein the polyalphaolefin has a dropping point, determined according to ASTM 5950, of at most −20° C., preferably at most −30° C.

38. The method of any one of Examples 35 to 37, wherein the polyalphaolefin has a density, determined according to ASTM D4052, of up to 0.860 g cm⁻³, in particular between 0.825 g cm⁻³ and 0.855 g cm⁻³.

39. The method of any one of examples 35 to 38, wherein the polyalphaolefin has an average molecular weight Mw, determined according to DIN 55672-1, of at least 440 Da, preferably between 440 Da and 12000 Da, particularly preferably between 1000 Da and 10000 Da, even more preferably between 3000 Da and 10000 Da.

40. The method of any one of examples 35 to 39, wherein the polyalphaolefin is a metallocene polyalphaolefin, in particular the polyalphaolefin was prepared using a metallocene catalyst.

41. The method of any one of examples 35 to 40, wherein the polyalphaolefin is a homopolymer or a copolymer, in particular the polyalphaolefin comprises a C3 to C22 alpha-olefin as (co)monomer.

42. The method of any one of examples 35 to 41, wherein the polyalphaolefin comprises a C6 to C14 alpha-olefin, preferably a C8 to C10 alpha-olefin, as (co)monomer.

43. The method of any one of Examples 35 to 41, wherein the polyalphaolefin contained in the polymer composition is between 0.1% by weight and 50% by weight, preferably between 0.1% by weight and 40% by weight, more preferably between 2% by weight and 30% by weight, even more preferably between 2% by weight and 25% by weight, most preferably between 3% by weight and 15% by weight.

44. The method of any one of the preceding examples, wherein the polymer composition comprises up to 15% by weight, preferably up to 8% by weight, more preferably up to 6% by weight, most preferably up to 5% by weight, of additives.

45. The method according to the preceding example, wherein the additives are selected from the group consisting of: pigments, nucleating agents, brighteners, stabilizers, surfactants, lubricants, antioxidants, and combinations thereof.

46. The method of any one of the preceding examples, wherein the polymer composition has an oxygen transmission rate, determined according to DIN 53380, of less than 5000 cm³ m⁻² d⁻¹ bar⁻¹, more preferably of less than 4000 cm³ m⁻² d⁻¹ bar¹, more preferably of less than 3000 cm³ m⁻² d⁻¹ bar¹, more preferably less than 2500 cm³ m⁻² d⁻¹ bar¹, more preferably less than 2000 cm³ m⁻² d⁻¹ bar⁻¹, more preferably less than 1300 cm³ m⁻² d⁻¹ bar¹, more preferably less than 900 cm³ m⁻² d⁻¹ bar¹, more preferably less than 750 cm³ m⁻² d⁻¹ bar¹.

47. The method of any one of the preceding examples, wherein the polymer composition has a total migration, determined according to DIN-EN 1186-14, of at most 5.5 mg cm⁻², preferably at most 3.5 mg cm⁻², particularly preferably at most 2.5 mg cm⁻², most preferably at most 1.5 mg cm².

48. A vessel closure for closing an opening of a vessel, wherein
(a) the vessel closure comprises a sealing element and the sealing element comprises a polymer composition,
(b) the polymer composition contains at least one polymer,
(c) the polymer composition has a Shore A hardness, determined according to DIN ISO 7619 with a hold time of 15 s and a temperature of 23° C., of at most 80, and the polymer composition has a compression set, determined according to ASTM D 395, 70° C., 22 h, of at least 50%.

49. The vessel closure of example 48, wherein the vessel closure is a screw closure, in particular a lug cap closure, and the vessel closure is screwed onto the vessel mouth.

50. The vessel closure of example 48 or 49, wherein the vessel closure is a metal closure.

51. Vessel closure of any one of examples 48 to 50, wherein the Shore A hardness, determined according to DIN ISO 7619 with a hold time of 15 s and a temperature of 23° C., of the polymer composition is at most 75, preferably at most 70, more preferably at most 65, particularly preferably between 30 and 65.

52. A vessel closure of any one of examples 48 to 51, wherein the compression set of the polymer composition, determined according to ASTM D 395, 70° C., 22 h, is at least 50%, preferably at least 60%, more preferably at least 65%, more preferably at least 70%, more preferably at least 75%, more preferably at least 80%, even more preferably at least 85%.

53. A vessel closure of any one of examples 48 to 52, wherein the polymer composition contains less than 10% by weight of polyvinyl chloride (PVC), preferably less than 5% by weight of PVC, preferably less than 2% by weight of PVC, particularly preferably no PVC.

54. A vessel, the vessel having an opening closed by a vessel closure, wherein the opening of the vessel is surrounded by a vessel mouth, and wherein the vessel closure is a vessel closure of any one of claims 48 to 53.

55. The vessel of example 54, wherein the vessel is a glass vessel.

56. The vessel of example 54 or 55, wherein a volume of at most 5 L, preferably at most 3 L, particularly preferably at most 1 L, can be accommodated by the vessel.

57. The vessel of any one of examples 54 to 56, wherein a granular filling material, in particular a granular filling material having a water content of at most 10% by weight, is stored in the vessel.

58. The vessel of any one of examples 54 to 57, wherein the vessel, in particular ahead space of the vessel, is pressurized with an inert gas, in particular nitrogen.

59. The vessel of any one of examples 54 to 58, wherein a head space of the vessel is filled with a gas, wherein the inert gas proportion, in particular the nitrogen proportion, in the gas is at least 78.5% by volume.

60. The vessel of any one of examples 54 to 59, wherein the absolute pressure in the vessel at 23° C. is above 1 bar, preferably above 1.1 bar, more preferably above 1.2 bar, more preferably above 1.3 bar, more preferably above 1.4 bar.

61. The vessel of any one of examples 54 to 60, wherein the vessel closure can be unscrewed from the vessel mouth by a torque of at most 3.4 Nm {30 inch lbs.), preferably at most 2.8 Nm (25 inch lbs.), more preferably at most 2.3 Nm (20 inch lbs.), even more preferably between 0.3 Nm (3 inch lbs.) and 2.8 Nm (25 inch lbs.).

62. A vessel of any one of examples 54 to 61, wherein the vessel closure is applied to the vessel mouth such that an interior of the vessel is vented starting from an overpressure of at least 0.3 bar, preferably at least 0.5 bar, more preferably at least 0.7 bar, even more preferably at least 1.0 bar.

63. The vessel of any one of examples 54 to 62, wherein the vessel closure has an outer diameter between 40 mm and 100 mm.

64. The vessel of any one of examples 54 to 63, wherein the vessel closure can be unscrewed from the vessel by a rotation relative to the vessel of at most 270°, preferably at most 180°, more preferably at most 120°.

65. A method for producing a sealed vessel, wherein
(a) a vessel closure with a sealing element is provided, wherein the sealing element comprises a polymer composition and the polymer composition contains at least one polymer, wherein the Shore A hardness of the polymer composition, determined according to DIN ISO 7619 with a hold time of 15 s and a temperature of 23° C., is at most 80;
(b) a vessel having an opening is provided, wherein the opening of the vessel is surrounded by a vessel mouth;
(c) an inert gas is introduced into a head space of the vessel; and
(d) the vessel closure is applied to the vessel mouth in such a way that the opening of the vessel is closed by the vessel closure.

66. The method of example 65, wherein the inert gas has a concentration of nitrogen of at least 78.5% by volume, preferably at least 80.0% by volume, more preferably at least 85.0% by volume, more preferably at least 90.0% by volume, more preferably at least 95.0% by volume, more preferably at least 98.0% by volume.

67. The method of any one of examples 65 and 66 having one or more of the features of examples 2 to 47, in particular without the features of example 1.

68. A vessel, in particular a (glass) beaker, having an opening closed by a lug cap closure, wherein the vessel comprises a head space and wherein an inert gas is introduced into the head space.

69. The vessel of example 68, wherein the inert gas in the head space has a higher volumetric fraction (% by volume) than in air.

70. The vessel of any one of examples 68 or 69, wherein the inert gas has a concentration of nitrogen of at least 78.5% by volume, preferably at least 80.0% by volume, more preferably at least 85.0% by volume, more preferably at least 90.0% by volume, more preferably at least 95.0% by volume, more preferably at least 98.0% by volume.

71. The vessel of any one of examples 68 to 70 having one or more of the features of Examples 55 to 64, in particular without the features of example 54.

72. The vessel of any one of examples 68 to 71, wherein the lug cap closure has one or more of the features of examples 48 to 53.

1. A method for producing a sealed vessel, wherein
(a) a vessel closure with a sealing element is provided, wherein the sealing element comprises a polymer composition and the polymer composition contains at least one polymer, wherein the Shore A hardness of the polymer composition, determined according to DIN ISO 7619 with a hold time of 15 s and a temperature of 23° C., is at most 80;
(b) a vessel having an opening is provided, wherein the opening of the vessel is surrounded by a vessel mouth;
(c1) the vessel closure is applied to the vessel mouth so as to close the opening of the vessel, wherein the sealing element has a temperature of at most 80° C. during application of the vessel closure to the vessel mouth;
and/or
(c2) an inert gas is introduced into ahead space of the vessel, and the vessel closure is applied to the mouth of the vessel such that the opening of the vessel is sealed by the vessel closure.

2. The method of claim 1, wherein the vessel closure is a screw closure, in particular a lug cap closure, and the vessel closure is screwed onto the vessel mouth.

3. The method of any one of the preceding claims, wherein a granular filling material, in particular a granular filling material with a water content of at most 10% by weight, is introduced into the vessel.

4. The method of any one of the preceding claims, wherein the compression set of the polymer composition, determined according to ASTM D 395, 70° C., 22 h, is at least 50%, preferably at least 60%, more preferably at least 65%, more preferably at least 70%, more preferably at least 75%, more preferably at least 80%, even more preferably at least 85%.

5. The method of any one of the preceding claims, wherein the polymer composition comprises at least 30% by weight, preferably at least 40% by weight, more preferably at least 50% by weight, more preferably at least 60% by weight, more preferably at least 70% by weight, even more preferably at least 80% by weight, most preferably at least 90% by weight, of a 1-butene copolymer.

6. The method of any one of the preceding claims, wherein the polymer composition comprises a polymer having a Shore D hardness, determined according to DIN ISO 7619-1 at 23° C., of at least 8, preferably of at least 20, more preferably of at least 40, in particular at most 70, preferably between 40 and 70; and/or
wherein the polymer composition contains a polymer having a Shore A hardness, determined according to DIN ISO 7619-1 at 23° C., of at least 40, preferably of at least 60, more preferably of at least 80, more preferably of at least 90.

7. The method of any one of the preceding claims, wherein the polymer composition comprises a propene copolymer, preferably wherein the propene copolymer is a propene-ethylene copolymer, in particular a propene-ethylene bipolymer.

8. The method of any one of the preceding claims, wherein the polymer composition comprises a 1-butene homopolymer.

9. The method of any one of the preceding claims, wherein the polymer composition comprises an ethene polymer, preferably wherein the density of the ethene polymer is between 0.87 g cm⁻³ and 0.94 g cm⁻³, in particular the ethene polymer is an ethene homopolymer, in particular LDPE.

10. The method of any one of the preceding claims, wherein the polymer composition comprises a random copolymer, preferably wherein ethene is a comonomer of the random copolymer, more preferably wherein ethene and a C3 to C10 alpha-olefin are comonomers of the random copolymer; and/or
wherein the polymer composition contains a block copolymer, preferably wherein ethene is a comonomer of the block copolymer, more preferably wherein ethene and a C3 to C10 alpha-olefin are comonomers of the block copolymer.

11. The method of any one of the preceding claims, wherein the polymer composition comprises a polyalphaolefin having a kinematic viscosity, determined according to ASTM D445/ISO 3104, of at least 4 cSt, at a temperature of 100° C., and/or having a dropping point, determined according to ASTM 5950, of at most −10° C.

12. A vessel closure for closing an opening of a vessel, wherein
(a) the vessel closure comprises a sealing element and the sealing element comprises a polymer composition,
(b) the polymer composition contains at least one polymer,
(c) the polymer composition has a Shore A hardness, determined according to DIN ISO 7619 with a hold time of 15 s and a temperature of 23° C., of at most 80, and the polymer composition has a compression set, determined according to ASTM D 395, 70° C., 22 h, of at least 50%.

13. A vessel, the vessel having an opening closed by a vessel closure, wherein the opening of the vessel is surrounded by a vessel mouth, and wherein the vessel closure is a vessel closure according to claim 12.

14. The vessel of claim 13, wherein a head space of the vessel is filled with a gas, wherein the proportion of inert gas, in particular the proportion of nitrogen in the gas is at least 78.5% by volume.

15. The vessel of claim 13 or 14, wherein the absolute pressure in the vessel at 23° C. is above 1 bar, preferably above 1.1 bar, more preferably above 1.2 bar, more preferably above 1.3 bar, more preferably above 1.4 bar.
